(19) United States
(12) Patent Application Publication
(10) Pub. No.: US 2019/0344422 A1
(43) Pub. Date: Nov. 14, 2019

(54) Cage Assembly and Electrically Powered Tool Having Cage

(71) Applicants: Bosch Power Tools (China) Co., Ltd., Hangzhou, Zhejiang (CN); Robert Bosch GmbH, Stuttgart (DE)

(72) Inventor: Wei Chen, Hangzhou, Zhejiang (CN)

(21) Appl. No.: 16/474,390

(22) PCT Filed: Dec. 29, 2017
(86) PCT No.: PCT/CN2017/119761

§ 371 Date: Jun. 27, 2019

(30) Foreign Application Priority Data
Dec. 30, 2016 (CN) 201611254854.8

(51) Int. Cl. B25F 5/02

(52) U.S. Cl. CPC B25F 5/021; B25F 5/029

(57) ABSTRACT

An electrically powered tool includes a cage assembly that has a cage, driving component, executing component, and cylindrical housing. The cage includes a base, a rear cage extending rearwards from the base, and a front cage extending forwards from the base. The driving component is positioned on the rear cage. The executing component is positioned on the front cage, and includes an output shaft extending forwards. The driving and executing components are positioned on the cage so as to form the cage assembly. The cage assembly is received in the cylindrical housing, and is configured to be mounted in the cylindrical housing in a modular fashion. Prior to insertion in the housing, the driving and executing components are jointly mounted into the cage to form the cage assembly so as to reduce structural redundancy via fixing and fitting, such that an overall body of the assembly smaller and more compact.

### TECHNICAL FIELD

The present application relates to an electric power tool, and in particular to an electric power tool having a holder.

### BACKGROUND ART

Electric power tools, such as electric screwdrivers, typically comprise batteries, circuit boards, electric motors, gearboxes, and other related components. In recent years, ever-increasing functions, such as torque control and power management, have brought more complex and larger-sized circuit board designs. In addition, the structural limitations of the axial superposition of many components pose a challenge for the miniaturized design of the electric power tools. At the same time, due to the large number of scattered parts, the general electric power tool often has a two-piece housing that is split in half, and the assembly is completed by bolting the housing and clamping the parts. However, such a design requires bolt holes pre-formed in the housing, which is another reason for restricting the compactness and miniaturization of the volume of the electric power tool due to the consideration of its own hole thickness, giving way to internal elements, etc.

Therefore, there is a need to provide a compact electric power tool design to overcome the technical problem existing in the prior art.

### SUMMARY OF THE INVENTION

The main problem to be solved by the present application is the compact design problem of the electric power tool.

In order to solve the above technical problem, in an aspect, the present application provides a holder assembly for an electric power tool, comprising: a holder having a base portion, a rear holder formed to extend rearward from the base portion, and a front holder formed to extend forward from the base portion; a driving component arranged at the rear holder; and an execution component arranged at the front holder and provided with a forward-extending output shaft, wherein the driving component and the execution component are assembled to the holder and jointly form the holder assembly, and the holder assembly can be mounted in an inserted manner into a tubular housing in a front-rear direction.

Further, the driving component comprises at least a battery, and the execution component comprises an electric motor and a reduction gear set.

Further, the driving component further comprises a circuit board, and the rear holder is provided with a battery accommodation portion and a circuit board accommodation portion which are provided parallel to the output shaft.

Further, the holder assembly further comprises at least some of connection components for electrically connecting the driving component and the execution component to constitute a working circuit.

Further, the holder assembly further comprises a start switch which is assembled to the base portion and participates in constituting the working circuit, the start switch being a micro switch or a pressure sensitive switch, and one end of the execution component that is close to the base portion is provided with a switch pressing portion mating with the start switch.

Further, the execution component is arranged in the front holder in such a way that the execution component can move forward and rearward, and the driving component is fixedly arranged at the rear holder.

In another aspect, the present application further provides an electric power tool, comprising a tubular housing which is integrally injection molded and has a sleeve cavity, and the holder assembly as described, wherein the sleeve cavity has an axial opening, and the holder assembly is embedded into the housing from the axial opening.

Further, the cavity of the housing is provided with a stop portion, the electric power tool further comprises an end cover assembled to the axial opening, and the holder assembly is limited between the stop portion and the end cover after the end cover is assembled to the housing.

Further, the execution component is arranged in the front holder in such a way that the execution component can move forward and rearward, and the driving component is fixedly arranged at the rear holder.

Further, the electric power tool further comprises a pre-placement component for elastically pre-placing the execution component at the end away from the driving component.

Further, the holder assembly further comprises a reversing switch, and an outside wall of the tubular housing is provided with an operating portion which can drive the reversing switch.

Further, an outer wall of the integrally injection molded tubular housing has a recess and forms a corresponding contracted portion in the cavity, and the stop portion is disposed at the contracted portion.

Further, the sleeve cavity is further provided with a guide component for guiding the mounting of the holder assembly.

According to the present application, the design that the driving component and the execution component are jointly assembled to the holder to form the holder assembly before the embedding reduces the structural redundancy caused by the fixing and mating functions, thereby making the entirety more compact and miniaturized.

Further provided is a holder assembly for an electric power tool, which can be mounted in an inserted manner into a tubular housing in a front-rear direction, wherein the holder assembly comprises a holder, a driving component and an execution component, the holder has a rear holder at which the driving component is arranged and a front holder at which the execution component is arranged, and the execution component is provided with a forward-extending output shaft.

Further, the driving component comprises at least a battery, and the execution component comprises an electric motor and a reduction gear set.

Further, the driving component further comprises a circuit board, and the rear holder is provided with a battery accommodation portion and a circuit board accommodation portion which are provided parallel to the output shaft.

Further, the holder assembly further comprises at least a portion of connection components for electrically connecting the driving component and the execution component to constitute a working circuit.

Further, the holder assembly further comprises a base portion located between the front holder and the rear holder and a start switch which is assembled to the base portion and participates in constituting the working circuit, the start switch being a micro switch or a pressure sensitive switch, and one end of the execution component that is close to the base portion is provided with a switch pressing portion mating with the start switch.

Further, the execution component is arranged in the front holder in such a way that the execution component can move forward and rearward, and the driving component is fixedly arranged at the rear holder.

Further provided is an electric power tool, comprising a tubular housing which is integrally injection molded and has a sleeve cavity, and the holder assembly of any one of claims 1-5, wherein the sleeve cavity has an axial opening, and the holder assembly is embedded into the housing from the axial opening.

Further, the sleeve cavity of the housing is provided with a stop portion, the electric power tool further comprises a rear cover assembled to the axial opening, and the holder assembly is limited between the stop portion and the rear cover after the rear cover is assembled to the housing.

Further, the execution component is arranged in the front holder in such a way that the execution component can move forward and rearward, and the driving component is fixedly arranged at the rear holder.

Further, the electric power tool further comprises a pre-placement component for elastically pre-placing the execution component at the end away from the driving component.

Further, the holder assembly further comprises a reversing switch, and an outside wall of the tubular housing is provided with an operating portion which can drive the reversing switch.

Further, an outer wall of the integrally injection molded tubular housing has a recess and forms a corresponding contracted portion in the sleeve cavity, and the stop portion is disposed at the contracted portion.

Further, the sleeve cavity is further provided with a guide component for guiding the mounting of the holder assembly.

### BRIEF DESCRIPTION OF THE DRAWINGS

The present application will be more fully understood upon reading the following detailed description of particular embodiments with reference to the accompanying drawings, in which:

FIG. 1 shows a schematic perspective structural diagram of an electric power tool of the present application;

FIG. 2 is a schematic cross-sectional structural diagram of the electric power tool of FIG. 1 taken along the A-A direction;

FIG. 3 shows a schematic exploded structural diagram of the electric power tool of the present application in the cross-sectional state of FIG. 2;

FIG. 4 shows a schematic exploded structural diagram of the electric power tool in FIG. 1;

FIG. 5 shows a schematic exploded structural diagram of a holder assembly and a housing of FIG. 4 before assembly; and

FIG. 6 shows a schematic exploded structural diagram of the electric power tool in FIG. 1 viewed from another angle.

### DETAILED DESCRIPTION OF EMBODIMENTS

Specific embodiments of the present application are described in detail below in conjunction with the accompanying drawings. In various drawings, the same or similar components are denoted by the same reference numerals. At the same time, it should be understood that the drawings are merely used to illustrate the present application, and the dimensions of the components, the scale and the number of the components in the drawings are not intended to limit the present application. Furthermore, it should be noted in advance that the so-called terms “front” and “front end” in the present application refer to the end of the electric power tool that is axially close to an object to be operated, and “rear” and “rear end” refer to the end of the electric power tool that is axially far away from the object to be processed.

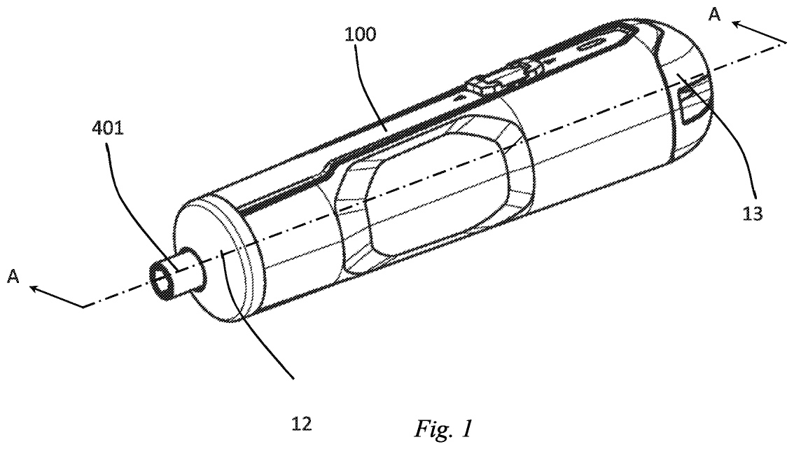

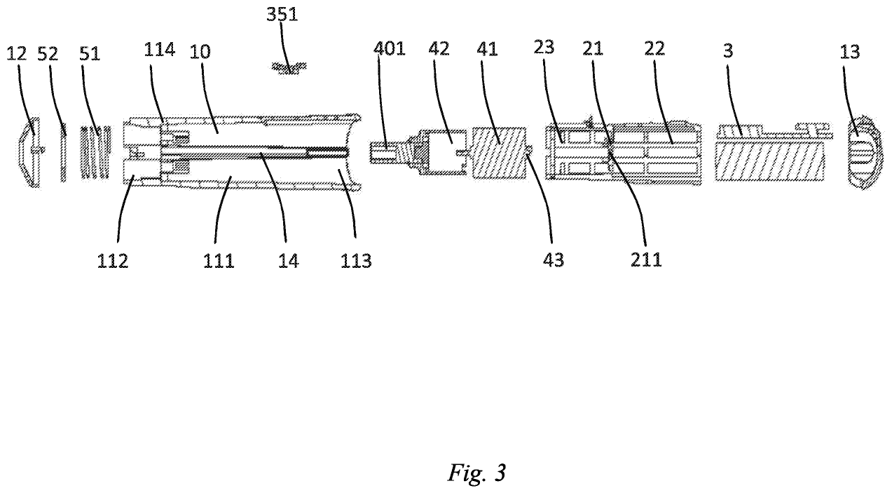

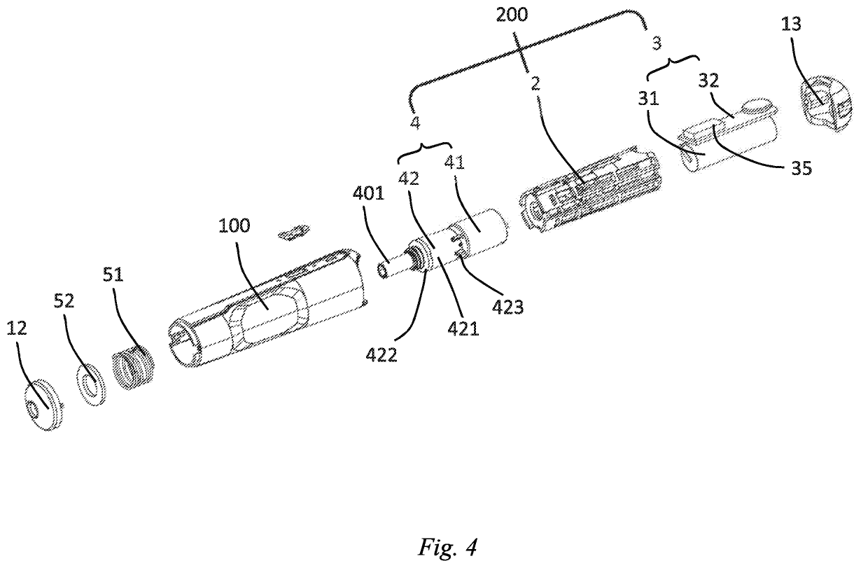

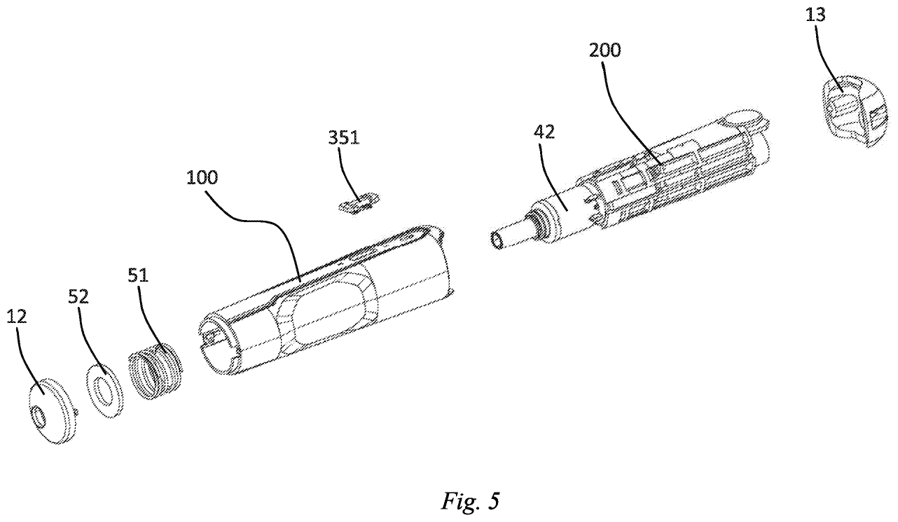

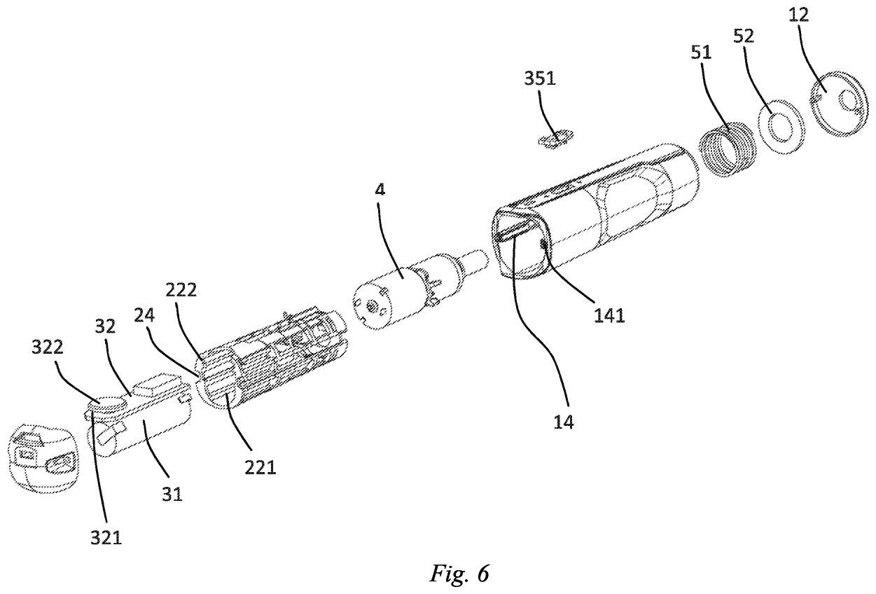

Referring to FIGS. 1 to 6, and particularly referring to FIGS. 3 and 4, an electric power tool provided in a specific embodiment of the present application is a straight-shank screwdriver, comprising a tubular housing 100 and a holder assembly 200 assembled within the tubular housing 100. The holder assembly 200 comprises a holder 2, a driving component 3, and an execution component 4. In this embodiment, the holder 2 is integrally injection molded, and has a base portion 21, a rear holder 22 formed to extend rearward from the base portion 21, and a front holder 23 formed to extend forward from the base portion 21; the driving component 3 is arranged at the rear holder 22; and the execution component 4 is arranged at the front holder 23 and is provided with an output shaft 401 extending forward and located at the front end of the straight-shank screwdriver, the output shaft 401 substantially coinciding with the geometric axis of the straight-shank screwdriver. The driving component 3 refers to a component that provides power and circuit management for the electric power tool, and in this embodiment, comprises a battery 31 and a circuit board 32, specifically a columnar battery and an elongated circuit board, wherein the columnar battery 31 and the rectangular circuit board 32 are parallel to the output shaft 401 and at least partially overlap in the front-rear direction, a core line of the columnar battery 31 does not coincide with the output shaft 401, and the output shaft 401 is not in the board plane of the circuit board 32; and the core line here refers to the axis of a carbon pole rod of the columnar battery, and if the battery is cylindrical, the core line substantially coincides with the axis of the cylinder. The execution component 4 refers to a component that performs motion and torque output, and in this embodiment, comprises an electric motor 41 and a reduction gear set 42 which are coaxially disposed. The reduction gear set 42 is covered by a gearbox 421 and is integrally press-fitted to the electric motor 41. The electric motor 41 is located at the rearmost end of the execution component 4 and has an outer diameter larger than the gearbox 421, the gearbox 421 has a front end face 422 and the output shaft 401 extending from the front end face 422 and located at the front end of the tubular housing 100, and the output shaft 401 is further provided with a bit holding portion (not labeled) adapted to a corresponding bit (not shown) for completing the operation.

The driving component 3 and the execution component 4 are arranged at the holder 2 to form a holder assembly 200 which can be modularly embedded into the tubular housing 100. The execution component 4 of the holder assembly 200 is arranged in the front holder 23 in such a way that it can move forward and rearward, and the driving component 3 is fixedly arranged at the rear holder 22. Of course, the holder assembly 200 further comprises at least a portion of connection components for electrically connecting the driving component 3 and the execution component 4 to constitute a working circuit. For example, the holder assembly 200 of this embodiment comprises at least the battery 31, the circuit board 32 and the electric motor 41, or all or a portion of connection lines, additional control switches or breakpoints which need to wait for the entire electric screwdriver to be assembled before they can be electrically closed, etc. In the drawings, for the purpose of clearly revealing the overall structure, the connection components are not shown. The design that the driving component 3 and the execution component 4 are jointly assembled to the holder 2 to form the holder assembly 200 before the embedding modularizes the driving component 3 and the execution component 4 by means of the holder 2, and reduces the design redundancy caused by the fixing and mating structures, thereby making the entire screwdriver more compact and miniaturized.

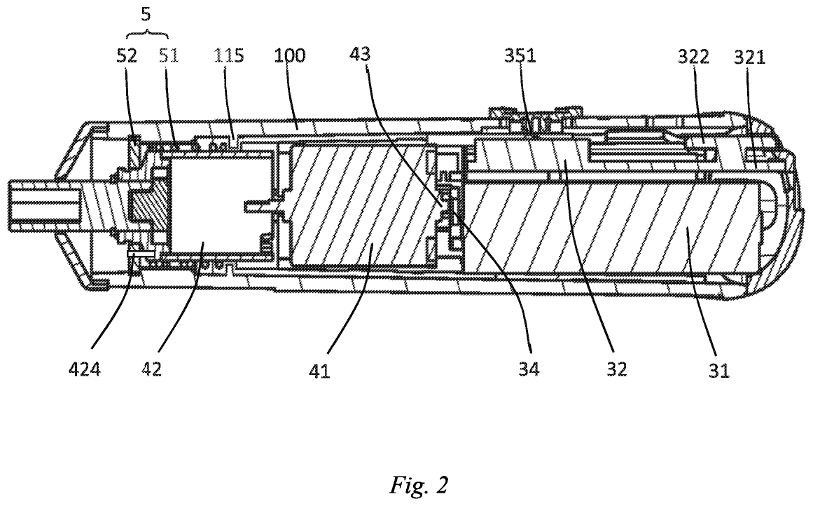

With continued reference to the drawings and with particular reference to FIGS. 2 and 3, the electric motor 41 is at least partially arranged at the front holder 23 and is movable in the front-rear direction (i.e., in the direction of the output shaft 401); the rear holder 22 is provided with a battery accommodation portion 221 and a circuit board accommodation portion 222 which are provided in the front-rear direction (i.e., in a direction parallel to the output shaft 401); and the battery 31 and the circuit board 32 are respectively accommodated and held in the battery accommodation portion 221 and the circuit board accommodation portion 222. In addition, the eccentric arrangement of the battery 31 and the electric motor 41 shown in this embodiment provides a larger design space for the circuit board 32, and the circuit board 32 is designed in parallel with the front-rear direction so that additional elements on the circuit board, such as a charging port 321 (a Micro USB connecting port assembled at the rear end of the circuit board in this embodiment, which has a plugging direction parallel to the board plane of the circuit board 32 and a mounting face attached to the circuit board 32) and an electronic clutch 322 (which electronically adjusts the torque maximum value of the screwdriver, and also has a mounting face attached to the circuit board 32, the specific form of the electronic clutch described in this embodiment is a disk-shaped torque knob), can have a large mounting area and in turn can be distributed with high intensity on an outer side face or a rear end face of the tubular housing 100.

The tubular housing 100 is integrally injection molded and penetrates in the front-rear direction, and has a sleeve cavity 111 and axial openings in communication with the sleeve cavity 111. The axial openings specifically include a front opening 112 and a rear opening 113. The tubular housing 100 further comprises a front cover 12 assembled to the front opening 112 and a rear cover 13 assembled to the rear opening 113, wherein the rear cover 13 is generally arched, and comprises an end edge matching the rear opening 113 and a protruding middle portion, the output shaft 401 is not in the plane of the circuit board 32, and the torque knob is exposed on a transition surface between the end edge and the projection, so that the curved transition surface can be used to naturally expose the torque knob to the rear cover 13. The tubular housing 100 is generally shaped to be small in the front and large in the rear, and is provided, at a position forward of the middle section, with a contracted portion 114 for facilitating gripping, and the contracted portion 114 is provided with a stop portion 115 at a position corresponding to the sleeve cavity 111. The stop portion 115 is specifically a closed stop ring or a segmented stop block. The rear end of the tubular housing 100 is square or quasi-square, and the circuit board 32 is substantially parallel to one side of the square or the quasi-square, so that a more efficient circuit board layout can be obtained. The sleeve cavity 111 is further provided with a guide component 14 extending in the front-rear direction, and the outer periphery of the holder 2 is provided with a guide groove 24 mating with the guide component 14. The holder assembly 200 is mounted into the sleeve cavity 111 from the axial opening (specifically, the rear opening 113 in this embodiment) and stops when the front end of the front holder 23 abuts against the rear side of the stop portion 115, and the gearbox 42 continues to extend forward through the stop portion 115, that is, the holder assembly 200 can be mounted in an inserted manner to the tubular housing 100 in the front-rear direction.

The electric screwdriver further comprises a pre-placement component 5 for elastically pre-placing the execution component 4 at the end away from the driving component 3, the pre-placement component 5 comprising a spring 51 mounted from the front opening 112 and sheathed over the outer periphery of the execution component 4 (specifically, the gearbox 421 in this embodiment). The rear end of the spring 51 abuts against the front side of the stop portion 115, and the front end thereof abuts against a side plate 52 extending from the execution component 4. In this embodiment, the side plate 52 is annular, the output shaft 401 passes through the side plate 52 and continues to extend forward. The side plate 52 is fixed to the gearbox 42 by means of a number of fastening holes 424 formed in the front end face 422. The outer periphery of the execution component 4 (specifically, the outer periphery of the electric motor 41) is provided with an anti-rotation portion 423 which cooperates with the holder 2 or the tubular housing 100 to achieve the circumferential limiting, so as to perform the circumferential limiting and anti-rotation on a stator of the electric motor and the execution component fixedly connected thereto. The driving component 3 further comprises a start switch 34, which is specifically a flat pressure sensitive switch in this embodiment, and a switch accommodation portion 211 for having the start switch 34 placed therein is concavely provided on the side of the base portion 21 that faces the front end. The execution component 4 is normally held elastically in a position where the start switch 34 is not triggered, and can cause the start switch 34 to be triggered when subjected to an external force. The flat start switch 34 is placed in the switch accommodation portion 211 in a posture perpendicular to the front-rear direction, and the electric screwdriver further comprises a switch pressing portion 43, which is disposed at the rear end of the execution component 4, specifically, at the rear end of the electric motor 41, and located in a pressing region of the flat start switch 34. Based on the pre-elastic force provided by the spring 51, the execution component 4 is kept away from the position of the start switch 34 (i.e., away from the base portion 21 of the holder 2) in a non-working state, whereas when the tubular housing 100 is held and applies an external force to an object to be processed, the execution component 4 overcomes the elastic force of the spring 51, such that the switch pressing portion 43 presses the start switch 34, and the driving component 3 starts supplying power to the execution component 4, causing the bit holding portion to rotate. According to the change in the magnitude of the external force applied to the start switch 34, the driving component 3 processes and feeds back different output torques to the execution component 4 to conform to the user's operating habits.

The front cover 12 is engaged to the front opening 112 of the tubular housing 100 after the spring 51 and the side plate 52 are mounted into the sleeve cavity 111 and fixed to the execution component 4, and the bit holding portion extends out of the front cover 12; and the rear cover 13 is fastened to the tubular housing 100 via a nut (not shown) after the holder assembly 200 is mounted into the sleeve cavity 111, specifically, the nut hole 141 in this embodiment is disposed in the guide component 14 of the tubular housing 100, which can make full use of the existing structures. The holder assembly 200 further comprises a reversing switch 35 integrated on the circuit board 32 and slidable in the front-rear direction, the reversing switch 35 participates in constituting the working circuit, and outside wall of the tubular housing 100 is provided with an operating portion 351 which can drive the reversing switch 35. After the rear cover 13 is assembled to the housing 100, the holder assembly 200 is confined between the stop portion 11 and the rear cover 13 and is completely accommodated inside the tubular housing 100. Moreover, the rear cover 13 assembled to the rear opening 113 is generally in the shape of an arch protruding in the middle, and the rear end of the circuit board 32 is arranged with the electronic clutch 322 parallel to the board plane and exposed to the arched rear cover 13. The electronic clutch 322 specifically provides a disk-shaped torque knob which is exposed to the arched rear cover 13 and is switched for adjustment. Since the output shaft 401 is not in the plane of the circuit board 32, the torque knob is not located on the middle protrusion of the arched rear cover 13, so that the torque knob can be exposed on the transition curved surface of the arched rear cover 13. The charging port 322 is mounted to the rear end of the circuit board 32 and has an end face parallel to the board plane of the circuit board 32 and exposed to the arched rear cover 13.

The above specific embodiments are merely illustrative of the inventive content of the present application and are not intended to limit the present application. For example, in the above embodiments, the reduction gear set is covered by the gearbox and is integrally press-fitted to the electric motor, but in other embodiments, the reduction gear set may be provided with no gearbox or directly built into a housing of the electric motor. Next, the turning on and turning off of the working circuit in this embodiment is implemented by pressing the pressure sensitive switch to start same, but in other embodiments, the use of a micro switch may also be chosen, and even the starting mode may take the form of dial starting or the like, which is commonly used in general designs. Further, this embodiment is specifically an electric screwdriver, but the compact design of the present application can also be applied to other electric power tools such as electric drills, electric hammers, etc.; and the contracted portion in this embodiment is provided with a stop portion at a position corresponding to the sleeve cavity, so that the contraction formed by the recessed structure thereof can be used to form the stop, but in other embodiments, even if there is no contracted portion design, the stop portion can be freely provided according to requirements. In summary, various changes and modifications can be made by those skilled in the art without departing from the scope of the present application. Therefore, all equivalent technical solutions are also within the scope of the present application, and the scope of protection of the present application is defined by the claims.

1. A holder assembly for an electric power tool, comprising:
a holder, including:
a rear holder; and
a front holder
a driving component positioned at the rear holder; and
an execution component, and including a forward-extending output shaft;
wherein the holder assembly is configured to be mounted, in an insertion fashion, into a tubular housing in a front-rear direction.

2. The holder assembly according to claim 1, wherein:
the driving component comprises includes at least a battery; and
the execution component further includes an electric motor and a reduction gear set.

3. The holder assembly according to claim 2, wherein:
the driving component further includes a circuit board; and
the rear holder includes a battery accommodation portion and a circuit board accommodation portion, each arranged paralled to the output shaft.

4. The holder assembly according to claim 1, further comprising:
connection components configured to electrically connect the driving component and the execution component so as to form a working circuit.

5. The holder assembly according to claim 4, further comprising:
a base portion positioned between the front holder and the rear holder; and
a start switch mounted on the base portion and forming a portion of the working circuit, wherein:
the start switch is a micro switch or a pressure sensitive switch; and
one end of the execution component that is close to the base portion includes a switch pressing portion that mates with the start switch.

6. The holder assembly according to claim 1, wherein:
the execution component is positioned in the front holder such that the execution component is moveable forward and rearward; and
the driving component is fixedly positioned at the rear holder.

7. An electric power tool, comprising:
a tubular housing formed as an integrally injection molded piece, and including a sleeve cavity having an axial opening; and
a holder assembly, including:
a holder, having:
a rear holder; and
a front holder
a driving component positioned at the rear holder; and
an execution component positioned at the front holder, and having a forward-extending output shaft
wherein the holder assembly is embedded into the housing in a front-rear direction via the axial opening.

8. The electric power tool accoding to claim 7, wherein:
the sleeve cavity of the housing further includes a stop portion;
the electric power tool further comprises a rear cover mounted to the axial opening; and
the holder assembly is limited between the stop portion and the rear cover when the rear cover is mounted to the housing.

9. The electric power tool according to claim 8, wherein:
the execution component is positioned in the front holder such that the execution component is moveable forward and rearward; and
the driving component is fixedly positioned at the rear holder.

10. The electric power tool according to claim 8, further comprising:
a pre-placement component configured to elastically pre-place the execution component at an end away from the driving component.

11. The electric power tool according to claim 8, wherein:
the holder assembly further includes a reversing switch; and
an outside wall of the tubular housing includes an operating portion configured to drive the reversing switch.

12. The electric power tool according to claim 8, wherein:
an outer wall of the integrally injection molded tubular housing includes a recess and forms a corresponding contracted portion in the sleeve cavity; and
the stop portion is positioned at the contracted portion.

13. The electric power tool according to claim 8, wherein the sleeve cavity further has a guide component configured to guide a mounting of the holder assembly in the sleeve cavity.
